(19) United States
(12) Patent Application Publication
(10) Pub. No.: US 2007/0164866 A1
(43) Pub. Date: Jul. 19, 2007

(54) Security document having a contactless chip with data masking

(76) Inventors: Philippe Robin, Bourg La Reine (FR); Elsa Missonge, Paris (FR); Pascal Zenoni, Boulogne-Billancourt (FR); Richard Lebourgeois, Gif Sur Yvette (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/582,714

(22) PCT Filed: Nov. 23, 2004
(86) PCT No.: PCT/EP04/53063

§ 371 Date: Jun. 12, 2006

(30) Foreign Application Priority Data
Dec. 12, 2003 (FR) 03 14597

(51) Int. Cl. G08B 13/14

(52) U.S. Cl. 340/572.7

(57) ABSTRACT

The present invention relates to a security document having a contactless chip with data masking. The security document comprising a transponder of an electronic module connected to an antenna placed on a given surface of a first part of the document, said transponder serving to remotely communicate with a reader via an electromagnetic coupling, and also comprises a passive masking element of said antenna, which is supported by a second part of the document and can move relative to said first part, said masking element being capable of interfering with the coupling between the transponder and the reader for rendering the reading of the document impossible when said second part is in a predetermined position that corresponds to a closed position of the document.

### CROSS-REFERENCE TO RELATED APPLICATIONS

The present Application is based on International Application No. PCT/EP2004/053063, filed on Nov. 23, 2004, which in turn corresponds to FR 03/14597 filed on Dec. 12, 2003, and priority is hereby claimed under 35 USC §119 based on these applications. Each of these applications are hereby incorporated by reference in their entirety into the present application.

### FIELD OF THE INVENTION

The present invention relates to a security document having a contactless chip with data masking.

### BACKGROUND OF THE INVENTION

Increasingly, security documents of the identity document type (passports, identity cards, etc), include an electronic circuit with contactless reading. The electronic circuit comprises an electronic module, or chip, connected to an inductive or capacitive antenna. This type of device can be used, for example, to store in digital form personal data concerning civil status and biometric data as well as administrative data. When the security document must be checked to verify its validity, for example, the stored data is read by a receiving device, or reader, via a remote electronic coupling between the electronic circuit of the card, otherwise called transponder, and the reader. The use of contactless technologies provides significant advantages in lifetime and ergonomic terms. However, it is important to assure the citizen that his identity document cannot be read without his knowledge. In practice, the contactless technology will be all the more accepted when the authorization to read data stored in the document remains under the control of the document holder.

### SUMMARY OF THE INVENTION

The object of the present invention is to restore the deliberate action on the part of the citizen to allow access to the data contained in a security document having a contactless chip. For this, the security document comprises a masking element, which is passive, designed to disturb the operation of the contactless coupling mechanism as long as the document-holder has not carried out this deliberate action to allow access to the document.

More specifically, the invention proposes a security document having a contactless chip comprising a transponder comprising an electronic module connected to an antenna placed on a given surface of a first part of the document, said transponder being designed to communicate remotely via an electromagnetic coupling with a reader. The security document also comprises a passive masking element of said antenna, supported by a second part of the document, which can move relative to said first part, said masking element being capable of disturbing the coupling between the transponder and the reader for rendering the reading of the document impossible when said second part is in a predetermined position, that corresponds to a closed position of the document.

The use of a passive element for masking the antenna also allows for a particularly simple and inexpensive implementation.

### BRIEF DESCRIPTION OF THE DRAWINGS

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention.

Accordingly, the drawings and description thereof are to be regarded as illustrative in nature, and not as restrictive.

FIGS. 1A, 1B, 1C, electronic diagrams illustrating the principle of communication between the transponder of a contactless chip document and a reader;

FIG. 2, an exemplary embodiment of a security document according to the invention, of passport type;

FIG. 3, an exemplary embodiment of a security document according to the invention, of card type with protective case.

In these figures, like elements are referenced by the same identifiers.

### DETAILED DESCRIPTION OF THE INVENTION

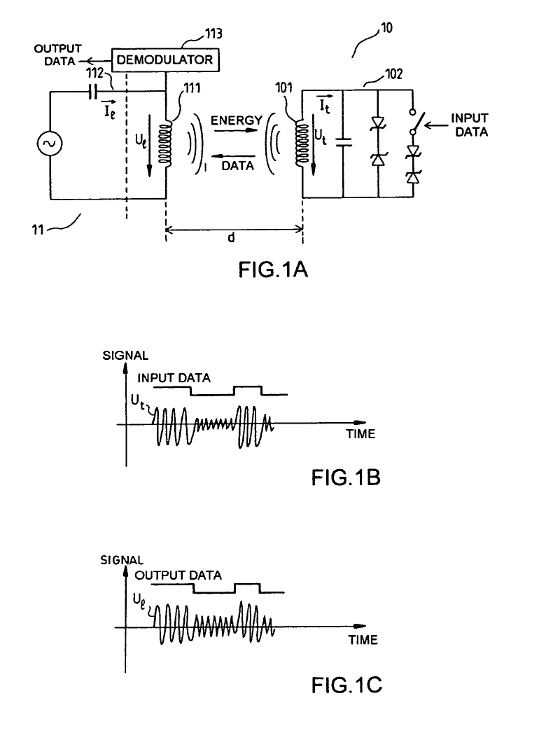

FIGS. 1A to 1C illustrate the principle of communication between the transponder 10 of a security document having a contactless chip and a reader 11, the transponder and the reader being represented by equivalent electrical diagrams.

The transponder 10 conventionally comprises an antenna, in this example an inductive antenna 101, for example in coiled wire form, or implemented by conductive ink screen printing or by etching a layer of copper, for example, connected to an electronic module, or chip 102. The communication with the reader 11 is conducted via a remote electromagnetic coupling. This coupling is set up in read mode or in read/write mode and the data is transmitted by radio or microwave frequencies. FIG. 1A illustrates the communication of the data from the transponder to the reader. Conventionally, the electric current passing through the antenna 111 of the reader fed by a circuit 112 causes the appearance of a magnetic flux. At a distance d, the instantaneous variation of this magnetic flux generates the appearance of a potential difference Ut induced at the terminals of the conductive element that is formed by the antenna 101 of the transponder, so enabling remote power feed to the electronic module 102 to which the antenna 101 is connected. After the transponder has been tuned to the carrier frequency of the reader, the order of magnitude of the voltage that can be used is typically a few volts. When the reader wants to have input data available in the transponder, it supplies the latter with a non-modulated carrier, so that it is still remote power-fed. According to a widely used transmission mode, the transponder digitally modulates the equivalent resistive load that it represents. By doing this, it modifies the energy consumption that it represents in the magnetic field and, because of the magnetic coupling existing between the transponder and the reader, tends to modify the value of the current Il circulating in the circuit of the antenna 111 of the reader. A demodulator 113 allows a part of the voltage Ul at the terminals of the antenna 111 to recover the output data. FIGS. 1B and 1C show, as a function of time, respectively the trend of the voltage Ut at the terminals of the antenna 101 modulated as a function of the input data and the potential difference Ul resulting from it at the terminals of the antenna 111 of the reader, and the trend of the output signal after demodulation.

The quality and quantity of the energy transfer depend on the frequencies to which the two antenna circuits are tuned. For example, the frequency 13.56 MHz is widely used.

The devices that use contactless chips, such as cards having contactless chips or other security documents, present major advantages in ergonomic and lifetime terms and are bound to be developed. A wide body of literature exists in this field and the implementation methods are well known from the state of the art (see, for example, patent application FR 2787609 on a method of fabricating cards having contactless chips).

However, when the security documents contain personal information such as civil status and biometric data, like a passport or an identity card for example, the document-holder may be entitled to ensure that this data will not be able to be read without his knowledge.

The invention proposes a security document with data masking enabling the document-holder to restore the deliberate action to allow the reading of the documents.

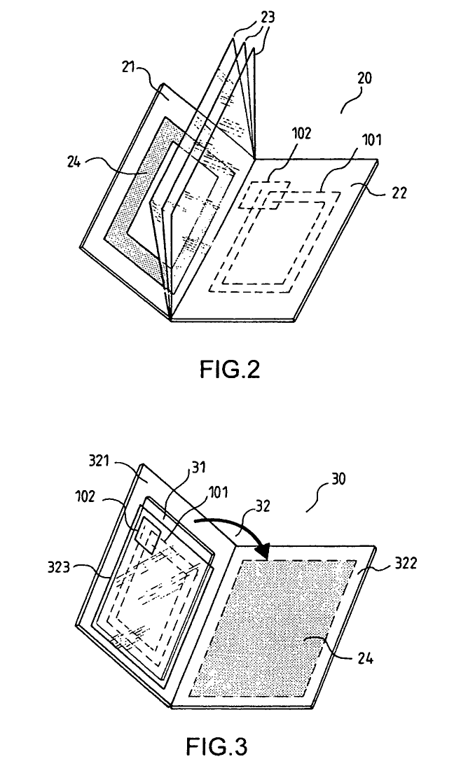

FIGS. 2 and 3 illustrate two nonlimiting examples of this. The first example is that of a passport type book 20, comprising two covers, front and back (21, 22), and a set of movable sheets 23. The second example is that of a card protected by a case (30).

According to the invention, the security document having a contactless chip comprises a transponder comprised of an electronic module 102 connected to an antenna 101. The antenna, conventionally in the form of a wound wire, is placed on a given surface of a first part of the document, for example one of the covers 22 of the book 20. The transponder is designed to communicate remotely via an electromagnetic coupling with a reader, not shown in FIG. 2. According to the invention, the security document also comprises a passive masking element 24 of the antenna, supported by a second part of the document (the cover 21 of the book in the example of FIG. 2), this second part being able to be moved relative to the first part. The masking element is a passive element, capable of disturbing the coupling between the transponder and the reader for rendering the reading of the document impossible when said second part is in a predetermined position that corresponds to a closed position of the document. Thus, in the example of FIG. 2, the masking element is chosen to make the reading impossible when the book is closed.

The passive masking element can be comprised of any material capable of disturbing the coupling, for example a metallic material or a magnetic material, in a manner sufficient to prevent reading. In practice, since the quality and the quantity of the energy transfer between the reader and the transponder depend on the frequencies to which the two antenna circuits are tuned, the coupling coefficient and the quality factors of the tuned circuits of the reader and the transponder, any electrical or magnetic disturbance of the antenna circuit of the transponder will result in a disturbance of the coupling.

The applicant has thus demonstrated that, with a passive masking element comprising a thin metallic layer of a given form, arranged in such a way that, when the document is in the closed position, said layer is facing the surface area covered by the antenna, the coupling diminishes very strongly to the point that the document is protected from any unwanted reading. The applicant has even observed that it was not necessary for all of the surface area covered by the antenna to be facing the metallic film. Thus, very good results have been obtained with a thin metallic layer of a form that is such that, when the document is in the closed position, the layer is facing the peripheral area of the surface area covered by the antenna, or at least a large part of this area. Thus, in the example of FIG. 2, the passive masking element 24 is comprised of a thin metallic layer, the form of which is roughly that of a box which, when the book is closed, is facing the peripheral area of the antenna 101 of the transponder.

According to a variant, the thin layer is formed from a sheet of metallic material, for example a sheet of aluminum. The thin layer can also be formed by means of a screen printed conductive paste on the part of the document intended to receive it, in this example the cover 21 of the book.

The applicant has observed in the exemplary embodiment of FIG. 2 that the results of masking the antenna were independent of the relative position of the reader in relation to the masking element. Thus, the reading of the document is disabled in the same way when the document is closed and when an attempt is made to read it by bringing the reader near the side of the cover 21 which supports the masking element or the side of the cover 22 which supports the transponder. Because of this, in the case of the book, the passive masking element can be supported immaterially by one of the covers, or one of the sheets, the only constraint being that it should be borne by an element of the book separate from that supporting the transponder.

Moreover, the thin metallic layer can be directly supported by the part of the document intended to receive it or formed on a support that will, for example, be glued to said part of the document. Thus, it is, for example, possible to glue onto a cover or a sheet of existing passports, a label on which is screen printed the masking element, so simply and inexpensively enabling protection against unwanted reading of existing security documents.

FIG. 3 represents another example of a security document having a contactless chip equipped with a masking element according to the invention. In this example, the document 30 is comprised of a card 31, for example an identity card, and a protective case 32. The antenna 101 of the transponder is supported by the card and the passive masking element 24 is supported by the case, such that the reading of the card is made impossible when the latter is stored in the case. For example, the case 32 comprises two flaps 321, 322, folded one over the other, a first flap 321 with a recess 323, for example made of plastic, in which the card is intended to be inserted, the second flap 322 supporting the passive masking element, in such a way that the reading of the card is made impossible when the flaps of the case are folded one over the other.

Of course, these exemplary embodiments are by no means limiting.

The use of a lossy magnetic material (and not a permanent magnet) is also possible to produce the passive masking element. This may be, for example, ferrite composites, in sheet form or deposited by printing on the second part of the security document, able to move in relation to the first part supporting the transponder.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by the definition contained in the appended claims and equivalent thereof.

1-9. (canceled)

10. A security document having a first part and a second part and having a contactless chip including a transponder comprising:
an electronic module connected to an antenna placed on a given surface of a first part of the document, said transponder being designed to communicate remotely via an electromagnetic coupling with a reader,
a passive masking element of said antenna, supported by said second part of the document, which can move relative to said first part, said masking element being capable of disturbing the coupling between the transponder and the reader for rendering the reading of the document impossible when said second part is in a predetermined position that corresponds to a closed position of the document.

11. The security document as claimed in claim 10, wherein the passive masking element comprises a thin metallic layer of a given form, arranged in such a way that, when the document is in the closed position, said layer is facing all or part of the surface area covered by the antenna.

12. The security document as claimed in claim 11, wherein the form of said layer is such that, when the document is in the closed position, said layer is facing all or part of the peripheral area of the surface area covered by the antenna.

13. The security document as claimed in claim 11, wherein said thin layer is formed from a sheet of metallic material.

14. The security document as claimed in claim 13, wherein said sheet is an aluminum sheet.

15. The security document as claimed in claim 11, wherein said thin layer is formed by means of a screen printed conductive paste.

16. The security document as claimed in claim 11, wherein said thin layer is directly supported by said second part of the document.

17. The security document as claimed in claim 11, wherein said thin layer is formed on a support glued to said second part of the document.

18. The security document as claimed in claim 10, wherein the passive masking area is formed from a lossy magnetic material.

19. The security document as claimed in claim 18, wherein said material is a ferrite composite.

20. The security document as claimed in claim 10 formed of a passport type book, with a set of interlinked elements, including a front cover, a back cover and one or more movable sheets, in which the first part and the second part of the document, respectively supporting the antenna and the passive masking element, are formed of two separate elements of the document, such that the reading of the document is made impossible in the closed position of the book.

21. The security document as claimed in claim 20, wherein the antenna and the masking element are respectively supported by each of the covers of the book.

22. The security document as claimed in claim 20, wherein the antenna and the masking element are respectively supported by one of said covers and one of said movable sheets.

23. The security document as claimed in claim 20, wherein the antenna and the masking element are respectively supported by one of the movable sheets and one of the covers or one of said other movable sheets.

24. The security document as claimed in claim 20, formed of a card and a protective case, in which, the antenna of the transponder being supported by said card forming said first element, the passive masking element is supported by the case forming said second element, such that the reading of the card is made impossible when the latter is stored in the case.

25. The security document as claimed in claim 24, wherein the case comprises two flaps that can be folded one over the other, a first flap with a recess in which the card is designed to be inserted, the second flap supporting the passive masking element, such that the reading of the card is made impossible when the flaps of the case are folded one over the other.
